(19) United States
(12) Patent Application Publication
(10) Pub. No.: US 2016/0372763 A1
(43) Pub. Date: Dec. 22, 2016

(54) Apparatus of Multifunctional Integrating Flow Battery

(71) Applicant: Institute of Nuclear Energy Research, Atomic Energy Council, Executive Yuan, R.O.C., Taoyuan City (TW)

(72) Inventors: Yung-Fang Lu, Taoyuan city (TW); Chin-Lung Hsieh, Taoyuan city (TW); Chung-Yao Hsu, Taoyuan city (TW)

(21) Appl. No.: 14/741,587

(22) Filed: Jun. 17, 2015

(51) Int. Cl. H01M 8/04; H01M 8/20; H02J 7/00; H01M 8/18

(52) U.S. Cl. CPC H01M 8/04007; H01M 8/188; H01M 8/20; H02J 7/0045; H02J 7/007

(57) ABSTRACT

A device of flow battery is provided. The device comprises a cell stack, a heat exchanger, an anode electrolyte tank, a cathode electrolyte tank, a circulating pump, a temperature-retaining tank, a charging/discharging unit, a DC/AC converter and a monitoring unit. The device can be assembled in a container to form a portable flow battery to be integrated into a mobile power pack or a stationary power supply. Thus, the present invention is portable and swappable. The device can adjust power output according to flows and energy-storing statuses for saving cost and maximizing benefit. Household electricity is provided through the DC/AC converter. AC of a mains supply is converted into DC to charge power to an electric vehicle through the charging/discharging unit. Electrolytes in the anode and cathode electrolyte tanks can be directly replaced for finishing charging power in a short time.

### TECHNICAL FIELD OF THE INVENTION

The present invention relates to flow battery; more particularly, relates to a portable power system of flow battery, where not only power-charging process is shortened and storage cost is reduced for maximizing efficiency; but also electrolytes used for an electric vehicle are directly replaced to charge power in a short time for effectively improving efficiency on charging power.

### DESCRIPTION OF THE RELATED ART

A flow battery usually has two huge containers, which contains electrolytes to be pumped to cell stack. The stack has a membrane within. A forward reaction is processed across the membrane between two electrolytes to produce electricity, where, on charging power, a reverse reaction is processed. It has been quite a long time on developing the flow battery, but a main drawback is the very huge volume and, hence, is not suitable to be used in a mobile device or a car.

In recent years, as following the development of renewable energies, needs of energy storage arise, which make the flow battery back to spotlight again. The flow battery can increase total capacity of energy storage by increasing capacity of electrolyte reservoir without the problem of the solid-liquid phase transition. It means the flow battery does not produce dendrite to rise problem on use life, Therefore, the flow battery can have almost unlimited use and save a lot of maintenance. The flow battery has high security and stability, which has no danger of fire or explosion when overcharged with power. Besides, if an energy storage device of power grid is a stationary facility, the size and portability of the flow battery are no more important, yet other characteristics become advantages. As a result, a lot of new businesses are put into operation for the flow battery.

Now, as following the rise of the market of storage batteries and electric vehicles, the flow battery is developed to be used as a mobile power for enhancing the use rate of the electric vehicles and replacing the traditional expensive lithium battery which is apt to be burned. The flow battery becomes a trend of modern storage energy industry. In the past, the price of the electric vehicle is one of the main obstacles on development. Yet, if a flow battery is used in an electric car, only a quarter price of lithium battery needs. Besides, because the electrolytes at two poles of the flow battery are stored separately, opportunity of mutual leakage is small and opportunity of self-discharge is also small with safety achieved, so that the energy can be stored for a long time. However, although there are advantages in safety and price, the flow battery is still applied to adjustment of peak and frequency in a substation and applied to a stationary firm of photovoltaics or wind power energy storage. If being used in a flow-cell electric vehicle, the flow battery cannot be charged with power quickly by direct swapping like a lithium battery and the control of power charging/discharging of the flow battery is also done artificially rather than automatically. Furthermore, voltage and current of the flow battery are unidirectional on charging/discharging power, but not bidirectional nor simultaneous.

Hence, the prior art does not fulfill all users' requests on actual use.

### SUMMARY OF THE INVENTION

The main purpose of the present invention is to use swappable flowing electrolytes, where, according to different applications of energy storage, power and energy outputted from a battery system are adjusted through flowing liquid and storing energy for saving charging process and reducing storage cost with maximized efficiency; according to application purposes, integration of a mobile power supply system (such as a system for electric vehicles, mobile devices, etc.) or a stationary power system (such as a system for electricity storage, flow battery charging and discharging, flow management, etc.) is completed; in an electric vehicle, electrolytes can be directly replaced to charge power in a short time for effectively improving efficiency on charging power; the electrolytes in a variety of flow batteries can be quickly replaced and filled for test; more than a set of multiple cell stacks, circulating pumps and circulating pipelines is used to simultaneously charge/discharge power; and, through different operating strategies and control parameters, accurate control and security monitoring are achieved.

Another purpose of the present invention is to use a temperature-retaining tank to control the whole system under a desired temperature range, where not only the whole system is maintained at a constant temperature, but also the temperature of the whole system is adjusted according to the external environment for adapting to a variety of harsh environments

To achieve the above purposes, the present invention is an apparatus of multifunctional integrating flow battery, comprising at least one cell stack, an anode heat exchanger, a cathode heat exchanger, an anode electrolyte tank, a cathode electrolyte tank, a temperature-retaining tank, a charging/discharging unit, and a monitoring unit, where the cell stack receives an anode electrolyte and a cathode electrolyte to generate and/or release direct-current (DC) power by processing electrochemical reactions according to the anode and cathode electrolytes; the cell stack separately outputs the anode and cathode electrolytes after the electrochemical reactions; the anode and cathode heat exchangers are connected to the cell stack to process heat exchange of the anode and cathode electrolytes, respectively; the anode and the cathode electrolyte tank holds the anode and the cathode electrolyte, respectively; the anode and the cathode electrolyte is delivered from the anode and the cathode electrolyte tank by a first and a second circulating pump unit, respectively; the anode and the cathode electrolyte separately passes through a flow control unit to control flow rate; after the anode and the cathode electrolyte enters into the cell stack to process the electrochemical reactions to generate and/or release DC power, the anode and the cathode electrolyte enters into the anode and the cathode heat exchanger to keep the anode and the cathode electrolyte in an optimum operating temperature range, respectively; after passing through the anode and the cathode heat exchanger, the anode and the cathode electrolyte returns back to the anode and the cathode electrolyte tank to form a cycling of the anode and the cathode electrolyte with coordination of the anode and the cathode electrolyte tank, the anode and the cathode heat exchanger and the cell stack to finish charging/discharging power, respectively; the temperature-retaining tank is separately connected to the anode and cathode heat exchangers and the anode and cathode electrolyte tanks to control the anode and cathode heat exchangers and the anode and cathode electrolyte tanks to be kept at a constant temperature by adjusting temperature according to an external environmental temperature; the charging/discharging unit is connected to the cell stack to charge/discharge power to/from the cell stack; the charging/discharging unit charges power through a conversion between DC and alternating current (AC) with a connection to a mains supply or a renewable energy; the charging/discharging unit discharges power through DC/AC conversion with a connection to a load; the monitoring unit automatically monitors the flow control units to control flow rates, valves switch-ons/offs, pressures and flow-cycling frequencies through instructions; the monitoring unit processes multifunctional controls through the pressures and the flow-cycling frequencies; and the monitoring unit adjusts the flow rates, the pressures and the flow-cycling frequencies under different states of charge/discharge (SOC/SOD). Accordingly, a novel apparatus of multifunctional integrating flow battery is obtained.

### BRIEF DESCRIPTION OF THE DRAWINGS

The present invention will be better understood from the following detailed description of the preferred embodiment according to the present invention, taken in conjunction with the accompanying drawings, in which

FIG. 1 is the structural view showing the preferred embodiment according to the present invention; and

FIG. 2 is view showing the components of the anode and the cathode electrolyte tank.

### DESCRIPTION OF THE PREFERRED EMBODIMENT

The following description of the preferred embodiment is provided to understand the features and the structures of the present invention.

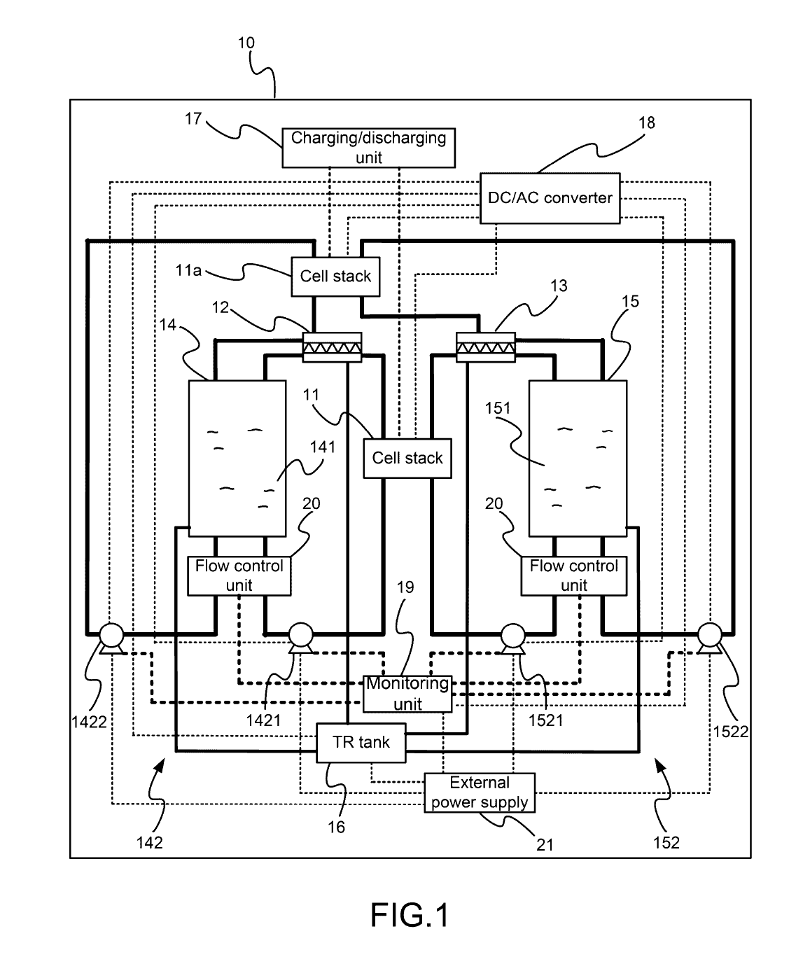

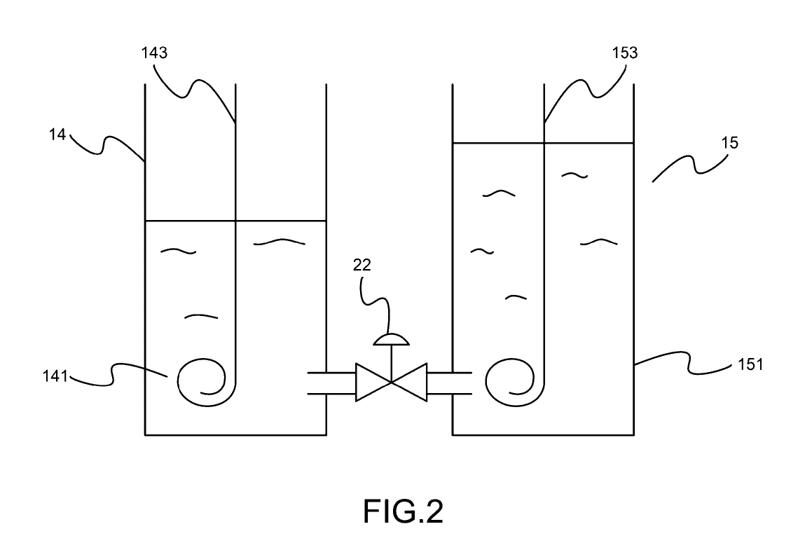

Please refer to FIG. 1 and FIG. 2, which are a structural view showing a preferred embodiment according to the present invention; and a view showing components of an anode and a cathode electrolyte tank. As shown in the figures, the present invention is an apparatus of multifunctional integrating flow battery, comprising two cell stacks 11,11a (or one of them), an anode heat exchanger 12, a cathode heat exchanger 13, an anode electrolyte tank 14, a cathode electrolyte tank 15, a temperature-retaining tank 16, a charging/discharging unit 17, a direct-current (DC)/alternating-current (AC) converter 18 and a monitoring unit 19.

The cell stacks 11,11a uses an anode electrolyte 141 and a cathode electrolyte 151 to generate and/or release DC power through electrochemical reactions and to output the anode electrolyte and the cathode electrolyte 141,151 obtained after processing the electrochemical reactions.

The anode and the cathode heat exchanger 12,13 is connected to the cell stacks 11,11a to process heat exchange of the anode and the cathode electrolyte 141,151 obtained after processing the electrochemical reactions, respectively.

The anode electrolyte tank 14 is stored with the anode electrolyte 141, where the anode electrolyte 141 is pumped out from the anode electrolyte tank 14 through circulating pumps and circulating pipelines of a first circulating pump unit 142. After controlling flow rate by the flow control unit 20, the anode electrolyte 141 is filled into the cell stacks 11,11a to complete the electrochemical reactions for generating and/or releasing DC power. After completing the electrochemical reactions, the anode electrolyte 141 enters into the anode heat exchange 12 to be kept in an optimum operating temperature range; and, then, is pumped back to the anode electrolyte tank 14. Thus, a cycling of the anode electrolyte 141 is formed with coordination of the anode electrolyte tank 14, the anode heat exchanger 12 and the cell stacks 11,11a to finish charging/discharging power. In FIG. 1, according to the number of the cell stacks 11,11a, the first circulating pump unit 142 comprises first and second circulating pumps 1421,1422 (or one of them) and at least one set of circulating pipelines.

The cathode electrolyte tank 15 is stored with the cathode electrolyte 151, where the cathode electrolyte 151 is pumped out from the cathode electrolyte tank 15 through circulating pumps and circulating pipelines of a second circulating pump unit 152. After controlling flow rate by the flow control unit 20, the cathode electrolyte 151 is filled into the cell stacks 11,11a to complete the electrochemical reactions for generating and/or releasing DC power. After completing the electrochemical reactions, the cathode electrolyte 151 enters into the cathode heat exchange 12 to be kept in an optimum operating temperature range; and, then, is pumped back to the cathode electrolyte tank 15. Thus, a cycling of the cathode electrolyte 151 is formed with coordination of the cathode electrolyte tank 15, the cathode heat exchanger 12 and the cell stacks 11,11a to finish charging/discharging power. In FIG. 1, according to the number of the cell stacks 11,11a, the second circulating pump unit 152 comprises third and fourth circulating pumps 1521,1522 (or one of them) and at least one set of circulating pipelines.

For simultaneously charging/discharging power with multiple stacks, the present invention can control the cell stacks 11,11a to charge power with them both; to discharge power with them both; or to charge power with one of the cell stacks 11,11a and discharge power with the other one of the cell stacks 11a,11. When the cell stacks 11,11a both charge power or both discharge power, the first circulating pump unit 142 which contains the anode electrolyte 141 is run by choosing any one of the first circulating pump 1421, along with its circulating pipelines, and the second circulating pump 1422, along with its circulating pipelines, or runs with them both. Similarly, the second circulating pump unit 152 which contains the cathode electrolyte 151 is run by choosing any one of the third circulating pump 1521, along with its circulating pipelines, and the fourth circulating pumps 1522, along with its circulating pipelines or runs with them both. When one of the cell stacks 11,11a charges power and the other one of the cell stacks 11a,11 discharges power, the first circulating pump unit 142 which contains the anode electrolyte 141 is run by using the first circulating pump 1421, along with its circulating pipelines, and the second circulating pump 1422, along with its circulating pipelines, while the second circulating pump unit 152 which contains the cathode electrolyte 151 is run by using the third circulating pump 1521, along with its circulating pipelines, and the fourth circulating pumps 1522, along with its circulating pipelines. Since the present invention can be connected to more than one set of multiple cell stacks, a number of circulating pumps along with circulating pipelines can be integrated according to the number of the cell stacks for charging/discharging power according to different requirements through various arrangements.

The temperature-retaining tank 16 is separately connected to the anode and cathode heat exchangers 12,13 and the anode and cathode electrolyte tanks 14,15 to control the anode and cathode electrolytes 141,151 and the cell stacks 11,11a to be kept in a temperature range, where not only a constant temperature is kept; but also a variety of harsh environments are adapted by adjusting component temperatures according to the external environmental temperature.

The charging/discharging unit 17 is connected to the cell stacks 11,11a to charge/discharge power to/from the cell stacks 11,11a. The charging/discharging unit 17 is connected to a mains supply or a renewable power supply to charge power through a DC/AC power inversion. Or, the charging/discharging unit 17 is connected to a load for discharging power through a DC/AC power inversion.

The monitoring unit 19 automatically monitors flow meters, proportion control valves, pressure sensors and frequency-varying device of the flow control unit 20. Through instructions, the monitoring unit 19 also controls flows, valves ons/offs, pressures and circulating pump frequencies. Besides, the monitoring unit 19 processes multifunctional controls through the pressures and the circulating pump frequencies, where the flows, the pressures and the circulating pump frequencies are adjusted under different states of charge/discharge (SOC/SOD) to achieve the best energy-saving and operational efficiency.

The present invention further comprises an external power supply 21, which can be renewable energy sources like mains, solar photoelectricity or wind power. On initializing the present invention, the external power supply 21 is used as a power supply source to provide AC power to the monitoring unit 19, the first circulating pump unit 142, the second circulating pump unit 152, the flow control unit 20 and the temperature-retaining tank 16. After activating the present invention to generate DC power, through the DC/AC converter 18, the DC power outputted by the cell stacks 11,11a is converted into AC power and the AC power thus generated is supplied to and used by the monitoring unit 19, the first circulating pump unit 142, the second circulating pump unit 152, the flow control unit 20, and the temperature-retaining tank 16.

The present invention further comprises an emergency-stop device (not shown in the figures), which immediately stops the present invention for emergency.

The pipeline between the anode and cathode electrolyte tanks 14,15 has a valve 22, which switches on/off according to compositions and liquid levels of the anode and cathode electrolytes 141,151. When the anode and cathode electrolytes 141,151 have the same compositions, the valve 22 controls switching-ons by presetting the schedule of switching-ons. When the liquid levels of the anode and cathode electrolytes 141,151 change and become different, the valve 22 opens to interlink the anode and cathode electrolyte tanks 14,15 to further make the liquid levels the same height. When the compositions of the anode and cathode electrolyte tanks 14,15 are not the same, the valve 22 is set to be always off. In addition, the valve 22 is connected with a pressurizing device (not shown in the figure), which speeds up flows through pressuring the flows to make the liquid levels the same height sooner.

An anode and a cathode mixing tube 143,153 are respectively set within the anode and the cathode electrolyte tank 14,15 to pour the refluxed anode and cathode electrolytes into tubes, and, then, mix with the original anode and cathode electrolytes 141,151 in the tanks.

A liquid collection tank (not shown in the figures) is set at the anode and cathode electrolyte tanks 14,15, the circulating pipelines and the cell stacks 11,11a for collecting the anode and cathode electrolytes leaked.

Thus, a novel apparatus of multifunctional integrating flow battery is obtained.

The present invention can be assembled within a container 10 to form a portable flow battery system, where the container 10 is used as a shell to be set up on a ship, a chassis car, a truck or a railway vehicle for transportation. According to application purposes, integration of a mobile power supply system (such as a system for electric vehicles, mobile devices, etc.) or a complete stationary power system (such as a system for electricity storage, flow battery charging and discharging, flow management, etc.) is completed. On using the present invention, the present invention provides required power by using switchable flowing electrolytes, where not only output power and energy of a battery system are adjusted through flowing liquid and storage energy according to different applications of energy storage for saving charging process and reducing storage cost with maximized efficiency; but also household electricity is obtained through an DC/AC converter or AC of a mains supply is provided by a charging/discharging unit to be converted into DC for use in an electric vehicle. The electrolytes can be directly replaced to charge power in a short time for effectively improving charging efficiency. Furthermore, the cell stacks can comprise different types of flow batteries, whose electrolytes can be swapped according to their types of flow batteries for quick replacement and filling and further being easily used in a variety of flow batteries for test. In addition, the present invention uses more than a set of multiple cell stacks, circulating pumps and circulating pipelines to simultaneously charge/discharge power; and, through different operating strategies and control parameters, accurate control and security monitoring are achieved. Furthermore, the temperature-retaining tank can control the whole module in a desired temperature range, where not only the whole module is maintained at a constant temperature, but also the temperature of the whole module is adjusted according to the external environment for adapting to a variety of harsh environments.

To sum up, the present invention is an apparatus of multifunctional integrating flow battery, where, by using swappable flowing electrolytes, not only output power and energy of a battery system are adjusted through flowing liquid and storing energy according to different applications of energy storage for saving charging process and reducing storage cost with maximized efficiency, but also the electrolytes can be directly replaced to charge power in a short time to effectively improve charging efficiency; the electrolytes in a variety of flow batteries can be quickly replaced and filled for test; a temperature-retaining tank can control the whole apparatus under a desired temperature range, so that not only the whole apparatus is maintained at a constant temperature, but also the temperature of the whole apparatus is adjusted according to the external environment for adapting to a variety of harsh environments; by using more than a set of multiple cell stacks, circulating pumps and circulating pipelines, simultaneous power charging/discharging is achieved; through different operating strategies and control parameters, accurate control and security monitoring are achieved; according to application purposes, integration of a mobile power supply system or a stationary power system is completed; and household electricity is obtained through an DC/AC converter or AC of a mains supply is provided by a charging/discharging unit to be converted into DC for use in an electric vehicle.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. An apparatus of multifunctional integrating flow battery, comprising
at least one cell stack,
wherein said at least one cell stack receives an anode electrolyte and a cathode electrolyte to generate and/or release direct-current (DC) power by processing electrochemical reactions according to said anode electrolyte and said cathode electrolyte; and outputs said anode electrolyte and said cathode electrolyte after said electrochemical reactions;
an anode heat exchanger,
wherein said anode heat exchanger is connected to said at least one cell stack to process heat exchange of said anode electrolyte;
a cathode heat exchanger,
wherein said cathode heat exchanger is connected to said at least one cell stack to process heat exchange of said cathode electrolyte;
an anode electrolyte tank,
wherein said anode electrolyte tank holds said anode electrolyte; said anode electrolyte is delivered from said anode electrolyte tank by a first circulating pump unit; said anode electrolyte passes through a flow control unit to control flow rate; after said anode electrolyte enters into said at least one cell stack to process said electrochemical reactions to generate and/or release DC power, said anode electrolyte enters into said anode heat exchanger to keep said anode electrolyte in an optimum operating temperature range; and, after passing through said anode heat exchanger, said anode electrolyte returns back to said anode electrolyte tank to form a cycling of said anode electrolyte with coordination of said anode electrolyte tank, said anode heat exchanger and said at least one cell stack to finish charging/discharging power;
a cathode electrolyte tank,
wherein said cathode electrolyte holds said cathode electrolyte; said cathode electrolyte is delivered from said cathode electrolyte tank by a second circulating pump unit; said cathode electrolyte passes through a flow control unit to control flow rate; after said cathode electrolyte enters into said at least one cell stack to process said electrochemical reactions to generate and/or release DC power, said cathode electrolyte enters into said cathode heat exchanger to keep said cathode electrolyte in an optimum operating temperature range; and, after passing through said cathode heat exchanger, said cathode electrolyte returns back to said cathode electrolyte tank to form a cycling of said cathode electrolyte with coordination of said cathode electrolyte tank, said cathode heat exchanger and said at least one cell stack to finish charging/discharging power;
a temperature-retaining tank,
wherein said temperature-retaining tank is separately connected to said anode and cathode heat exchangers and said anode and cathode electrolyte tanks to control said anode and cathode heat exchangers and said anode and cathode electrolyte tanks to be kept at a constant temperature by adjusting temperature according to an external environmental temperature;
a charging/discharging unit,
wherein said charging/discharging unit is connected to said at least one cell stack to charge/discharge power to/from said at least one cell stack; said charging/discharging unit charges power through a conversion between DC and alternating current (AC) with a connection to a resource selected from a group consisting of a mains supply and a renewable energy; and said charging/discharging unit discharges power through said DC/AC conversion with a connection to a load; and
a monitoring unit,
wherein said monitoring unit automatically monitors said flow control units to control flow rates, valves switch-ons/offs, pressures and flow-cycling frequencies through instructions; processes multifunctional controls through said pressures and said flow-cycling frequencies; and adjusts said flow rates, said pressures and said flow-cycling frequencies under different states of charge/discharge (SOC/SOD).

2. The apparatus according to claim 1,
wherein the apparatus further comprises a DC/AC converter to convert DC outputted from said at least one cell stack into AC to be provided to said monitoring unit, said first circulating pump unit, said second circulating pump unit, said flow control unit and said temperature-retaining tank.

3. The apparatus according to claim 1,
wherein the apparatus further comprises an external power supply to be a power supply source at a time of initial operation to provide AC to said monitoring unit, said first circulating pump unit, said second circulating pump unit, said flow control unit and said temperature-retaining tank.

4. The apparatus according to claim 1,
wherein said flow control unit comprises a meter unit, a proportional control valve, a pressure sensor and a frequency-varying device.

5. The apparatus according to claim 1,
wherein a valve is obtained in a pipeline connecting said anode and cathode electrolyte tanks and is set to on/off according to components and liquid levels of said anode and cathode electrolytes.

6. The apparatus according to claim 5,
wherein, while said anode and cathode electrolytes have the same components, said valve controls opening schedules by setting opening periods; and
wherein, while said components of said anode and cathode electrolytes change and said liquid levels are not the same, said valve is opened to make said liquid levels become the same.

7. The apparatus according to claim 5,
wherein, while said components of said anode and cathode electrolytes are not the same, said valve is set to be always off.

8. The apparatus according to claim 5,
wherein said valve is connected with a pressurizing device.

9. The apparatus according to claim 1,
wherein said anode electrolyte tank has an anode mixing tube contained within to receive backflow of said anode electrolyte to be mixed with source of said anode electrolyte in said anode electrolyte tank.

10. The apparatus according to claim 1,
wherein said cathode electrolyte tank has a cathode mixing tube contained within to receive backflow of said cathode electrolyte to be mixed with source of said cathode electrolyte in said anode electrolyte tank.

11. The apparatus according to claim 1,
wherein each of said first and said second circulating pump unit comprises at least one circulating pump and at least one circulating pipeline.

12. The apparatus according to claim 1,
wherein said anode electrolyte and said cathode electrolyte pass through circulating pipelines to form circulation by using said first circulating pump unit and said second circulating pump unit, respectively.

13. The apparatus according to claim 1,
wherein said anode electrolyte and said cathode electrolyte pass through circulating pipelines to form circulation by simultaneously using said first and said second circulating pump units.

14. The apparatus according to claim 1,
wherein, while a cell stack generates DC power and another cell stack releases DC power in said at least one cell stack, said anode electrolyte and said cathode electrolyte use two circulating pumps and two circulating pipelines in said first circulating pump unit and said second circulating pump unit, respectively.

15. The apparatus according to claim 1,
wherein a leaked-fluid slot is located at every one of said positive and said cathode electrolyte tanks, circulating pipelines and said at least one cell stack to collect leaked fluid of said positive and said cathode electrolytes.

16. The apparatus according to claim 1,
wherein the apparatus further comprises an emergency stop device to immediately stop operations while an emergency occurs.
